(19) United States
(12) Patent Application Publication
(10) Pub. No.: US 2005/0151506 A1
(43) Pub. Date: Jul. 14, 2005

(54) Battery charger with multiple functions

(76) Inventors: Rosalia Kennedy, Taipei Hsien (TW); Tony Wang, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/753,425

(22) Filed: Jan. 9, 2004

(51) Int. Cl. H02J 7/00

(52) U.S. Cl. 320/111

(57) ABSTRACT

The present invention relates to a battery charger with multiple functions comprises a charging unit and at least two adaptive connectors. The charging unit controls output voltages via software and has a display screen showing set voltages. A voltage select button provides convenience of voltage setting by touch button (or keys), the adaptive connector between the main charger and a charged device sets limited output voltages range, providing end user to select required voltages for various products. End users can power/charge many electrical products with one charger only.

### DESCRIPTION OF THE INVENTION

1. Field of the Invention

The present invention is a battery charger/adaptor with multiple functions. The invented battery charger/adapter not only controls output voltages through programmed software, it also controls output voltage ranges by selecting different adaptive connectors. With multiple programmable output voltage settings and adaptive connectors, the charger/adapter is capable to power and charge various electrical products with one charger only.

2. Background of the Invention

Most portable electrical products are produced with built-in charging devices and/or equipped with rechargeable batteries. These include mobile phones, notebooks, PDA, game machines, electrical tools, printers, walkman etc. Normally an adaptor/or charger is included for powering or charging the rechargeable battery by original manufacturers.

However, different products require different voltage/current. And each product is normally equipped with a designated charger/adaptor provided by original manufacturer. Consumers often become confused and annoyed as to which adaptor belongs to which product after obtaining many products with different chargers. Applying the wrong adaptor to a product can shorten the life of the product or may even destroy the product. Also carrying many battery chargers/adapters become very inconvenient to consumers.

In order to solve above problems, many chargers/adaptors in the current market include either mechanical switch to change the setting of voltages, or different pre-programmed connectors to change the voltages for different products. The mechanical switch described above has problem with damping effect that causes output voltage to be unstable. The changeable and pre-programmed connector is normally pre programmed by manufacturer without showing actual rating of voltage and current. Consumer cannot identify the voltage easily, which may cause confusion when two or more exact size connectors were programmed with different voltages.

### SUMMARY OF THE INVENTION

The first objective of the present invention is to provide a battery charger/adapter with multiple functions through digital memory software setting (programmed software). The battery charger comprises a charging unit and minimum of two adaptive connectors. The charging unit controls output voltages through programmed software and has a display screen showing selected voltages. A voltage selecting button provides the convenience of setting voltage by touch keys. The adaptive connector between the main charging unit and a charged device divides output voltages into two ranges. Each adaptive connector has its own voltage range for user's option. The purpose of this limited voltage range is to protect user from applying one (high) voltage range to the other (low) voltage range, vise versa. End users may charge many products by setting the requested voltage value themselves. The charger also includes functions of preset memory for frequent use.

The adaptive connectors described above include two types: First type of connector has total of three pins. The first and the second pins correspondingly connect to positive and negative electrodes to a charging product, the third pin is to set output voltage range, which has no connection to either first pin or second pin. The first connector will control output voltages from 3 to 9 volt, so called low voltage range. Second type also have three pins, but there is a connection between third pin and the second pin, thus controls the output voltage from 10 to 21 volt, so called high voltage range.

The second objective of the present invention is to have a 3 (three) pin socket to which the three pin adaptive connector is attached, thus preventing reversal of polarity during insertion.

The third objective of the present invention is that the charging unit has a preset memory function, it will automatically memorize the last two voltage settings from high and low voltage range for user's frequent use.

Additional objects and advantages of this invention will be set forth in part in the description which follows, and in part will be obvious from the description, or may be learned by practice of the invention. The objects and advantages of this invention can be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute as part of the specification, will illustrate several embodiments of the invention. And together with the description will serve to explain the principles of the invention.

### BRIEF DESCRIPTION OF THE DRAWINGS

FIG. 1 is a 3-D sketch of the present invention;

FIG. 2 is a sketch of another preferred embodiment of the present invention;

FIG. 3A is a sketch of an adaptive connector of the present invention;

FIG. 3B is a sketch of inner circuit of pins of a high voltage adaptor;

FIG. 3C is a sketch of inner circuit of pins of a low voltage adaptor;

FIG. 4 is a sketch of inner circuits of a charging unit of the present invention;

FIG. 5 is a sketch of a third preferred embodiment of the present invention;

FIG. 6 is a sketch of inner circuits of the third embodiment of the present invention.

### DESCRIPTION OF THE EMBODIMENTS

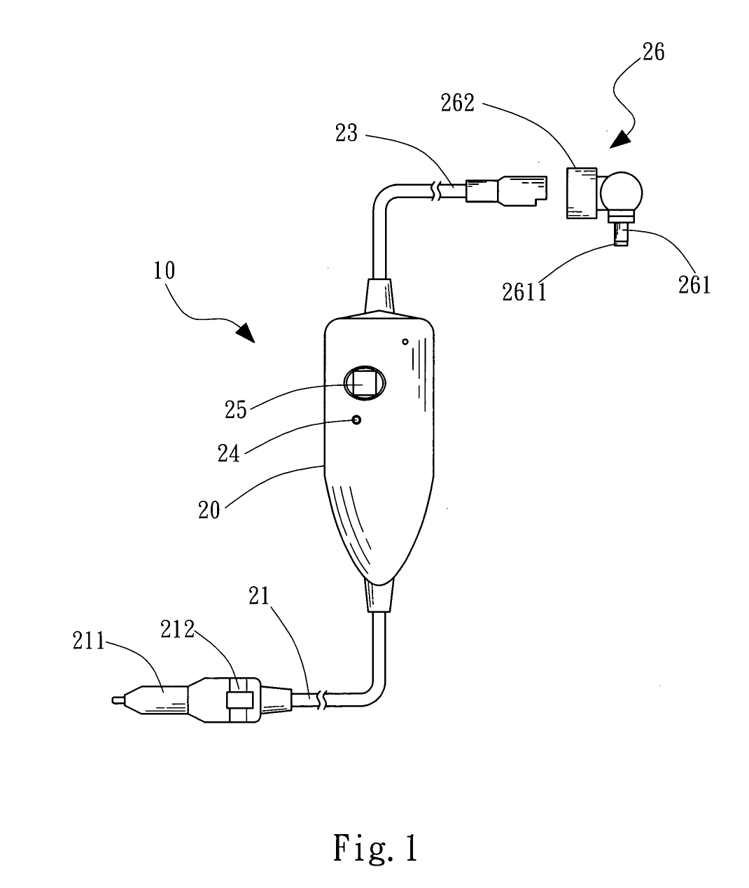

As shown in FIG. 1, is a 3-D sketch of the present invention. A multi-function battery charger 10 of the present invention comprises:

A charging unit 20 which includes one electrical input plug 21, one inner circuit 22 and one electrical output connecting socket 23. The electrical input plug 21 comprising a set of a car cigarette-lighter plug 211 and a plane seat connectors 212, which to be used as a power source for the charging unit 20.

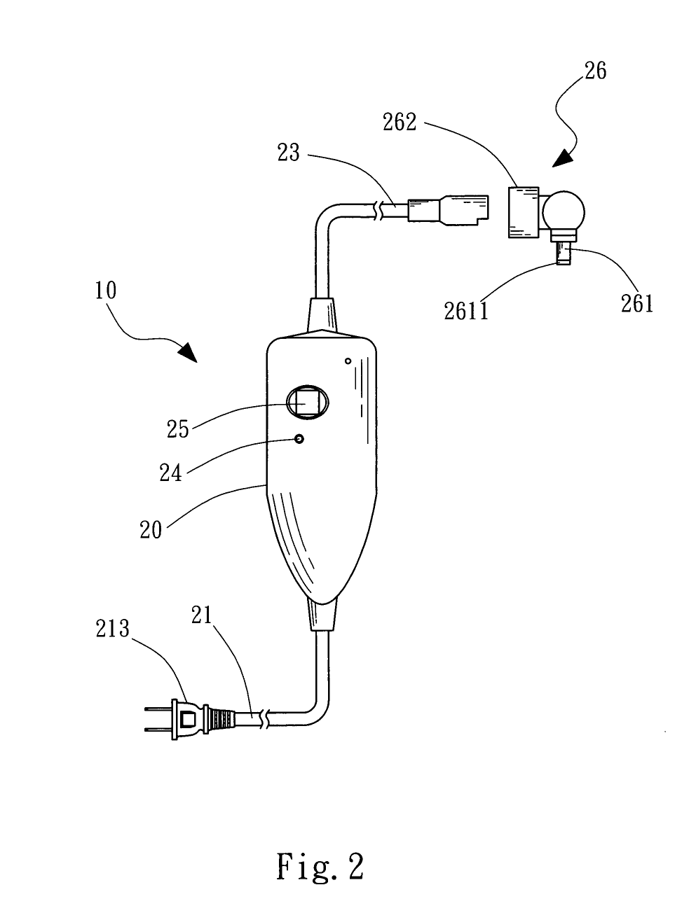

As shown in FIG. 2, is a sketch of another preferred embodiment of the present invention. The electrical input plug 21 might be a normal AC main plug, hence, a plug 231 transfers AC to DC through an inner rectification circuit and a transformer (not shown in figure).

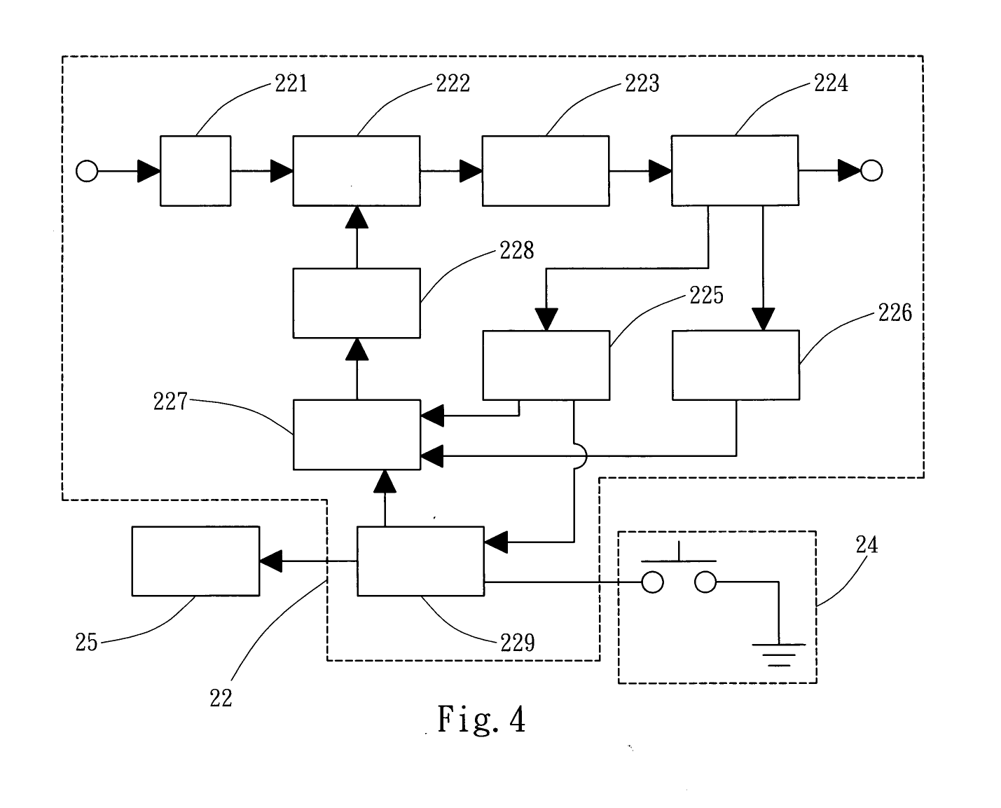

As shown in the FIG. 4 which is a sketch of inner circuits of a charging unit of the present invention. Inner circuits 22 comprise a main controlling unit 229 which controls output voltages via software. Part of 229 functions is to control an output voltage range of the inner circuits 22 according to the types of an adaptive connector 26 used. After insert the adaptive connector 26 to the output connecting socket 23 and set voltage by touch select button 24, the required voltage will show up on a display screen 25.

With output connecting socket 23 plugged into adaptive connector 26, the charged products will receive the power from the charging unit 22.

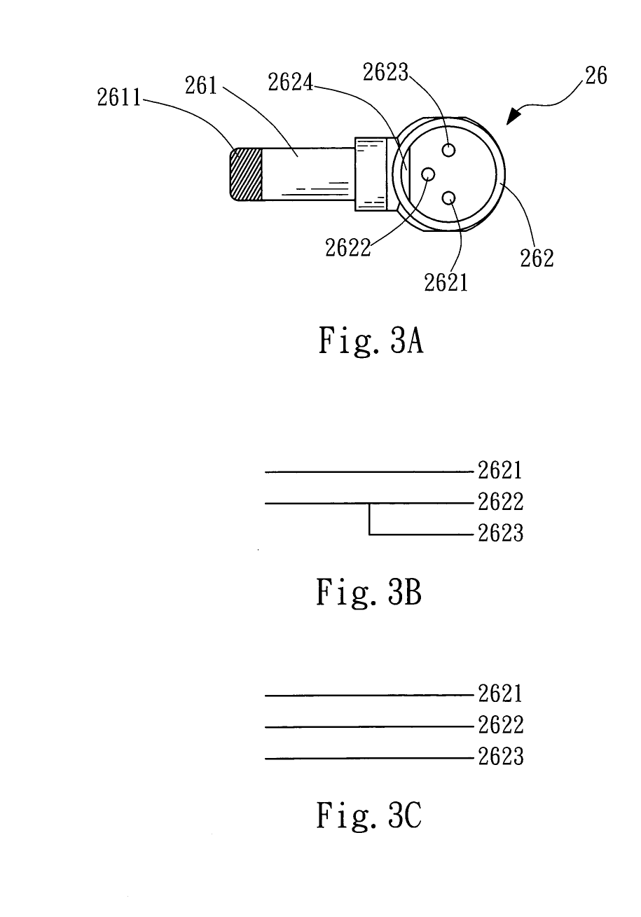

Referring to FIG. 3A, which is a sketch of an adaptive connector of the present invention. Two adaptive connectors 26 comprise the first plug-in pin 261 connecting to the charging device and the second plug-in pin 262 connecting to the output connecting socket 23. There are three pins inside the second plug-in pin 262, wherein, the first and the second pins 2621, 2622 connect to positive and negative electrodes of the first plug-in pin 261, the third pins 2623 is to set the output voltage range.

Referring to FIG. 3B, which is a sketch of inner circuit of pins of a high voltage adaptive connector. If a third pin 2623 connects to the second pin 2622, this means the charging unit 20 will output a high voltage range from 10 to 21 volt, so called high voltage adaptive connector. Referring to FIG. 3C, which is a sketch of inner circuit of pins of a low voltage adaptive connector. If the third pin 2623 is a type of floating-connecting, the charging unit 20 will output a low voltage range from 3 to 9 volt, so called low voltage adaptive connector.

The special designed adaptive connector 26 is to prevent unnecessary damage caused by output voltage being mis-used, such as applying higher voltage greater than specified voltage to the charged product. The second plug-in pin 262 of the adaptive connector 26 further comprises a preventing means 2624, shown in FIG. 3A; it is to limit the direction of insertion of the adaptive connector 26. It is to avoid user's wrong insertion that may result damaging a charged device. A label 2611 is on an outer surface of the first plug-in pin 261 to identify a high voltage adaptive connector from low voltage adaptive connector by colors.

Referring to FIG. 4, which is a sketch of inner circuits of a charging unit of the present invention. The inner circuit 22 comprises:

An EMI filter 221, depressing electromagnetism radiation of the input plug 21

A push & pull Buck switching circuits 222, which are controlled by PWM controlling circuits 227and driving circuits 228. It increases voltages from input plug 21 to a maximum value within adjustable field, such as 24 voltages in the preferred embodiment.

A transformer 223 controlled by the PWM controlling circuits 227, which transfers the maximum output voltage of the push & pull Buck switching circuits 222 to the voltage set by the voltage select button.

Output circuit 224, is in between the power output 23 and voltage detecting circuits 225 of the inner circuit 222. It provides output voltages from the transformer 223 through the transferring process. It also transfers a connection status of the adaptive connector 26 to a voltage detector 225.

The voltage detector 225, it is to detect connection status of the third pin 2623 of the adaptive connector 26, and controls the PWM controlling circuits 227 to produce controlling signals corresponding to the push & pull Buck switching circuits 222. Then it produces a maximum output voltage range respective to the connecting condition of adaptive connector 26;

Current limiting circuits 226, it limits output current of the output circuits 224, avoiding damage caused by higher current.

PWM controlling circuit—based on the detecting result of the voltage detector 225, and program of main controlling unit 229, the PWM controlling circuits 227 controls the driving circuit 228 to make the push & pull Buck switching circuits 222 to set voltages range corresponding to the condition of adaptive connector 26, and provides multiple output voltages within the voltage range.

Main controlling unit 229—Based on detecting result of voltage detector 225, main controlling unit 229 through PWM controlling circuits 227 produce an output voltage range, and set multiple voltage options through the select button 24. It will also provide the status of the voltage range and the switching status of the voltage on the display screen 25.

Besides, the main controlling unit 229 has a memory function to automatically memorize two last settings of the high and low voltage value for usage of next operation. The high voltage value is set within respective to the high voltage range; another is set within respective to the low voltage range.

User plugs the input plug 21 into a cigarette-lighter socket of a car or an airplane seat power source, and then inserts adaptive connector 26 into the output socket 23 to provide charging voltage required by the charging device. At this moment, PWM controlling circuits 227 and main controlling unit 229 produce the corresponding output voltage range based on the detecting result of voltage detector 225. The display screen 25 will show the voltage range, for example, user plugs the low voltage adaptive connector, (3 to 9 volt), the display screen 25 shows the setting up voltage within the voltage range immediately, and the main controlling unit 229 detects the action of selecting button 24 immediately.

User can select the output voltage by touching the voltage select button 24 and adjust each voltage by touching the select button 24 one time. In this embodiment, the adjusted range each time is half of one voltage for low voltage range, 3 to 9 volt. The low voltages can be divided into twelve (12) sections. The main controlling unit 229 detects the action of selecting button 24, after a short period of time, if there is no change the main control unit will take the selected voltage as required voltage.

Then main controlling unit 229 will drive the PWM circuit 227, the driving circuit 228 and the push & pull Buck switching circuit 222 then delivers the required voltage to the output socket 23, user can start charging the charging device. At this moment, the main controlling unit 229 drives the display screen 25 to show the selected voltage value and memorize this value.

Likewise, if the high voltage adaptive connector is used, in this embodiment, the high voltage range can be divided into twelve (12) sections between 10 to 21 volt, and each adjustment is one voltage. The selecting range of the select button 24 can also be changed by programming to the desired DC voltage range.

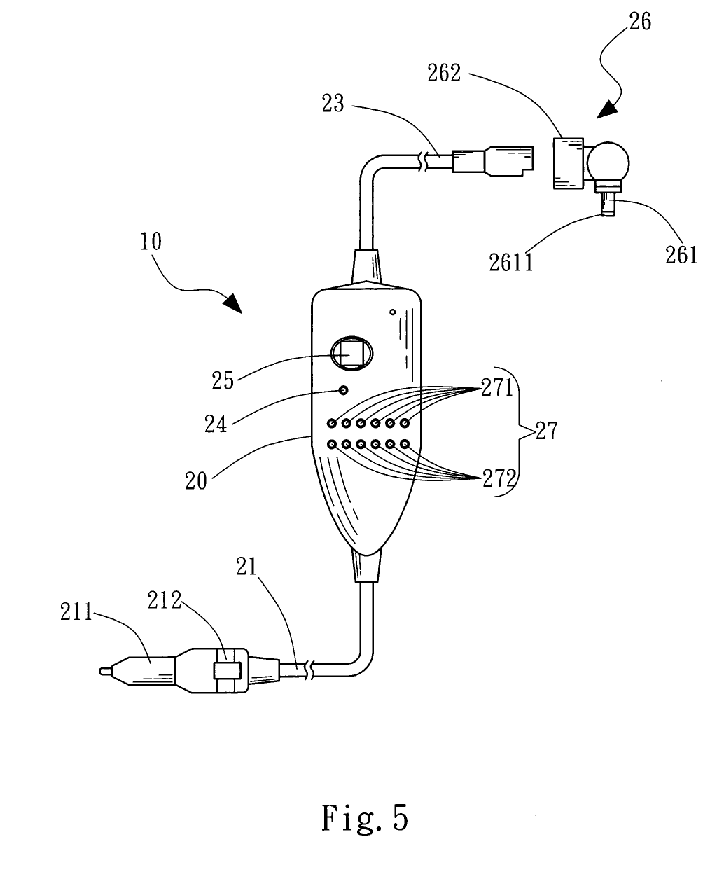

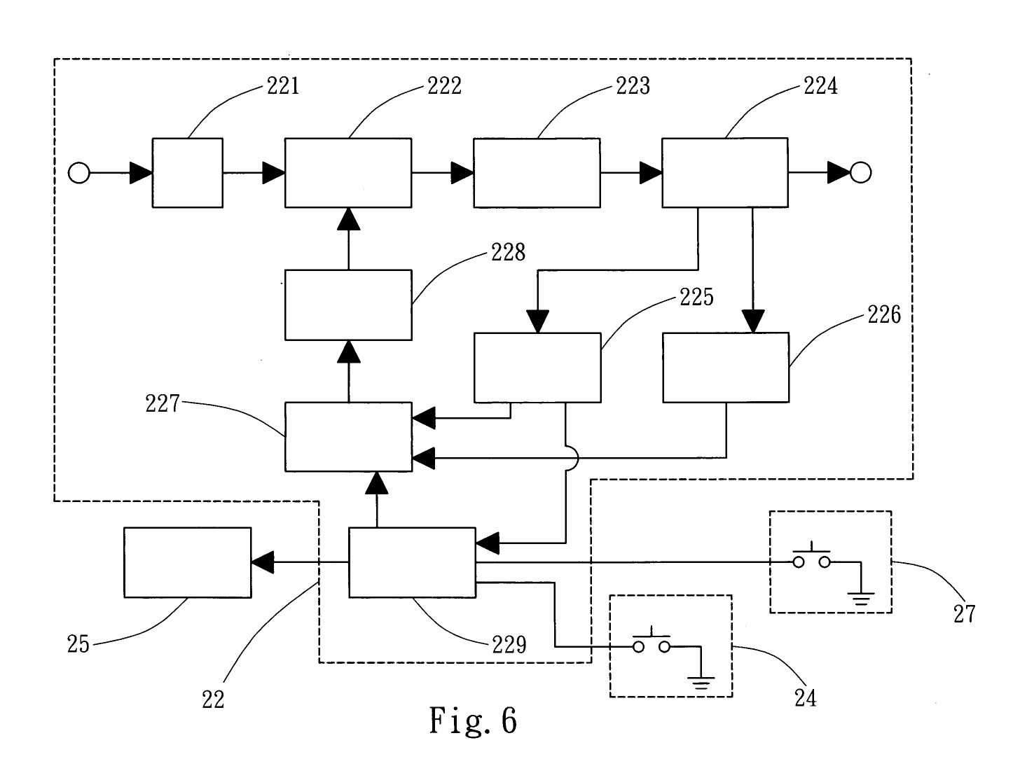

As shown in FIG. 5 and FIG. 6, which are a sketch of a third preferred embodiment of the present invention and a sketch of inner circuits of the third embodiment of the present invention. The controlling unit 229 of this embodiment, shown in FIG. 6, further cooperates with multiple callings and select buttons 27 of the charging unit. The multiple callings and select buttons 27 can call the memory data previously stored in the controlling unit 229. User can press the multiple callings and select buttons 27 to call for the needed memory data stored. When user wishes to charge different products, the output voltage of the present invention can be called out from stored data immediately without press voltage select button 24. To program the voltages of the multiple callings, select buttons 27 is used in stead of voltage selecting buttons 24. The multiple callings and select buttons 27 can be divided into many high voltage calling selecting buttons 271 and low voltage select buttons 272. Wherein, the memory of the low voltage multiple calling and select buttons 272 is corresponding to the data within the range of low voltage, relatively, the memory of the high voltage calling and select buttons 271 is corresponding to the range of the high voltage. Hence, user can't use the high voltage calling selecting buttons 271 when uses the low voltage adaptive connector 26. It prevents user using wrong adaptive connector 26 or presses the plural calling and select buttons 27 incorrectly.

Summarize the description above, the multi-function charger/adapter of the present invention not only solves the problems of the original battery charger's limited ability to charge only one device and it also solves it's inability to show the output voltage status. It provides the solution via software to offer wide range output voltages to satisfy consumers' multiple usages. Consumer can set the requested charging voltage themselves for as many AC or DC devices as possible. And at same time it displays the charging voltage on the display screen for easy review. The preset memory capability makes it user friendly for easy use. The protection of output voltage range and 3 pin insertions are extra protecting solutions that make this charger unique.

It is to be understood that while the invention has been described above in conjunction with preferred specific embodiments, the description and examples are intended to illustrate and not to limit the scope of the invention, which is defined by the scope of the appended claims.

1. A battery charger with multiple functions comprising:
an electrical input plug introduces an outer electrical source to a charging unit;
with at least two adaptive connectors between the charging unit and electrical device, charging units transfer the needed voltages to electrical devices;
the charging unit (battery charger) includes inner circuits, a display screen and a voltage select button, the inner circuit via specially programmed software gives adjustable voltage ranges, the voltage select button allows the inner circuits transfer an output voltage, the display screen presents a process of selecting voltages and setting results.

2. The battery charger with multiple functions as cited in claim 1, wherein the electrical input plug further comprises a set of air/auto plugs being used with both car cigarette-lighter socket and an airplane seat power source.

3. The battery charger with multiple functions as cited in claim 1, wherein the electrical input plug can be a domestic AC plug.

4. The battery charger with multiple functions as cited in claim 1, wherein the display screen can be one of following: LCD, LED display.

5. The battery charger with multiple functions as cited in claim 1, wherein the connectors comprises with a first adaptive connector connecting to the charged device and a second connector which is connected at end of charger output cable, the first adaptive connector has three pins therein, wherein the first and the second pins correspondingly connect to positive and negative electrodes of second socket, the third pin is to set output voltage range.

6. The battery charger with multiple functions as cited in claim 5, wherein the third pin connects to the second pin and sets a high voltage output range from the charger.

7. The battery charger with multiple functions as cited in claim 5, wherein the third pin is a type of floating-connection and sets a low voltage output range from the charger.

8. The battery charger with multiple functions as cited in claim 5, wherein preventing means is set by way of using the first pin of connecting socket and adaptive connector to prevent reverse of polarity.

9. The battery charger with multiple functions as cited in claim 5, wherein a label is on an outer surface of the adaptive connectors to divide a high voltage adaptive connectors from low voltage adaptive connectors by different colors.

10. The battery charger with multiple functions as cited in claim 1, wherein inner circuits comprise:
an EMI filter depressing electromagnetism radiation of the electrical input end;
push & pull Buck switching circuits which is controlled by both PWM controlling circuits and driving circuits, will increases voltages from electrical input end to a maximum value within adjustable field;
a transformer controlled by the PWM controlling circuits, transfers the maximum output voltage of the push & pull Buck switching circuits to the voltages set by the voltage select button;
output circuits, in between the power output and voltage detects circuit of the inner circuits, sends output voltage from the transformer after the transferring process, it also transfers a connection status of the adaptive connector to a voltage detector;
a voltage detector will detect connecting status of the third pin of the adaptive connector, then through the PWM controlling circuits to produce controlling signals corresponding to the push & pull Buck switching circuits, then produces a maximum output voltage range respective to the adaptive connector;
the PWM controlling circuit, based on detecting result, controls driving circuit to make the push & pull Buck switching circuits producing voltages ranges corresponding to the adaptive connectors and sets up multiple output voltage stages within the voltage range;
the main controlling unit controlling the PWM circuit, based on detecting result is to produce a different voltage output ranges, and multiple voltage outputs through a select button, then show the status of the voltage range and the switching status of the voltages on the display screen.

11. The battery charger with multiple functions as cited in claim 10, wherein inner circuits further includes current limiting circuits in order to limit the outputting current to prevent damage to the charged electrical device.

12. The battery charger with multiple functions as cited in claim 10, wherein the main controlling unit of the inner circuits has memory function to automatically memorize last two settings of voltage of the charger/adaptor.

13. The battery charger with multiple functions as cited in claim 12, wherein the main controlling unit can cooperate with multiple callings and selecting buttons of the charger, the calling and selecting buttons can call up memory data stored in the main controlling unit in advance.
